(19) United States
(12) Patent Application Publication
(10) Pub. No.: US 2012/0322434 A1
(43) Pub. Date: Dec. 20, 2012

(54) KIT FOR AN AUDIOVISUAL DEVICE OF A VEHICLE

(75) Inventors: Philippe Samuel, Neuilly Plaisance (FR); Gilles Pierson, Le Val de Geblange (FR)

(73) Assignee: PSB INVESTISSEMENT, Rosny sous Bois (FR)

(21) Appl. No.: 13/577,129

(22) PCT Filed: Feb. 1, 2011
(86) PCT No.: PCT/FR11/00061

§ 371 Date: Aug. 29, 2012

(30) Foreign Application Priority Data
Feb. 11, 2010 (FR) 1000565

(51) Int. Cl. H04W 4/00

(52) U.S. Cl. 455/418

(57) ABSTRACT

The invention relates to a kit for an audiovisual device of a vehicle, including a car radio module without a front surface, for installation in a recess of the dashboard, in interaction with an electrical power supply, a radio antenna, and at least one electroacoustic transducer, said car radio module being capable of automatically searching for stations, as well as a means for controlling said car radio module. Said audiovisual device also includes: a base for a so-called smart mobile telephone, the base being provided for installation on the dashboard, and including a connector for the telephone, and the power supply thereof, at least one radio application software program unit to be installed on the telephone to manage the radio functions of the car radio module, the telephone itself including telephone application software, and audio management application software, a relay conditioner having a processor, arranged to be interconnected between the base and elements of the car radio module, to receive the audio signals of the application software with sound from the telephone, and to receive the radio audio signals from a tuner; said relay conditioner includes an input selection switch to power a preamplifier, and an audio input manager which monitors the most recently launched application software, to control the input selection switch in accordance with whether or not the most recently launched application software is a radio application software.

The invention relates to the audiovisual equipment of vehicles.

It has become common to equip a vehicle not only with a car radio installation, with a cassette reader and then an optical disk reader (CD and then DVD), but also with a telephone function. At first, the so-called “Bluetooth” communication function of a cellular telephone was used in order to make it cooperate with the on-board installation of the vehicle. The advantage is that use can be made of everything that is in the mobile telephone, especially its address book. The disadvantage is that operation of the cellular telephone in the vehicle requires operations which present a certain difficulty for the uninitiated. As a result, the on-board installation of the vehicle has been equipped with a telephone function which reproduces the basic functions of a cellular telephone, essentially telephony and messaging. Some operators supply so-called twin SIM cards, which allow the cellular telephone line and a line attributed to the on-board telephone system of the vehicle to be coupled. It is even possible to copy the address book contained in the SIM card of the main cellular telephone.

More recently, so-called “smart” mobile telephones have appeared. They have numerous functionalities, and their user interface is particularly intricate. It is still possible to connect them with the on-board installation of a vehicle, for example by Bluetooth communication. However, in that case, control remains with the on-board installation of a vehicle, which is not entirely satisfactory.

The present invention aims to improve the situation.

The invention starts from a kit for an audiovisual device of a vehicle, of the type comprising on the one hand a car radio module without a front face plate, for mounting in a recess in the dashboard, in cooperation with a power supply, a radio antenna, and at least one on-board electroacoustic transducer, said car radio module being capable of automatically searching for stations, and on the other hand means for controlling the car radio module.

According to one aspect of the invention, the kit further comprises a base for a so-called smart mobile telephone, the base being provided for mounting on the dashboard and comprising a connector for the telephone, and its power supply, and at least one radio application which is to be installed on the telephone in order to manage radio functions of the car radio module, the telephone itself comprising a telephony application, and an audio application manager, a relay conditioner with a processor, which is arranged to be interconnected between the base and elements of the car radio module in order to receive from the telephone the audio signals of the applications with sound and to receive from the module the radio audio signals, the relay conditioner comprising an input selection switch for supplying a preamplifier, and an application manager which monitors the last application launched in order to control the input selection switch according to whether the last application launched is or is not a radio application.

Very advantageously, the kit further comprises an amplification function control application. And the relay conditioner comprises a converter for controlling the preamplifier as a function of parameters coming from said amplification function application.

According to another aspect of the invention, which is distinct from the first, the relay conditioner comprises a station search management function and a radio station selection function, both of which are under the control of said radio application.

Other features are of interest, separately or in combination:
said applications can be constructed from a basic user interface comprising a group of virtual buttons surmounted by a delimited navigation zone which is sensitive to touch parallel to the major axis of the buttons,
for the amplification function control application, the buttons correspond to the parameters bass, mid, treble, balance and fade, while the delimited navigation zone allows the parameter corresponding to the last button actuated to be set,
the radio application comprises a basic view where the buttons represent stored radio stations, while a current station is displayed in the delimited navigation zone, which allows a station in the band to be selected,
the kit comprises a setting application, one button of which controls whether or not the station search function is in use,

the kit comprises an application for setting the colours of said basic user interface,
the relay conditioner further comprises a connection for establishing communication between an on-board microphone and the telephone, at least for the telephony application,
the relay conditioner with a processor is mounted in the base between at least one connector to the telephone and at least one connector to the car radio module,
the base comprises an on/off command, which can be actuated in the presence of the telephone,
the base is pivotable between a horizontal position and a vertical position,
the kit is combined with a so-called smart mobile telephone paired with the base, that is to say its form and its connector match those of the base.

Other features and advantages of the invention will become apparent upon studying the detailed description below and the accompanying drawings, in which:

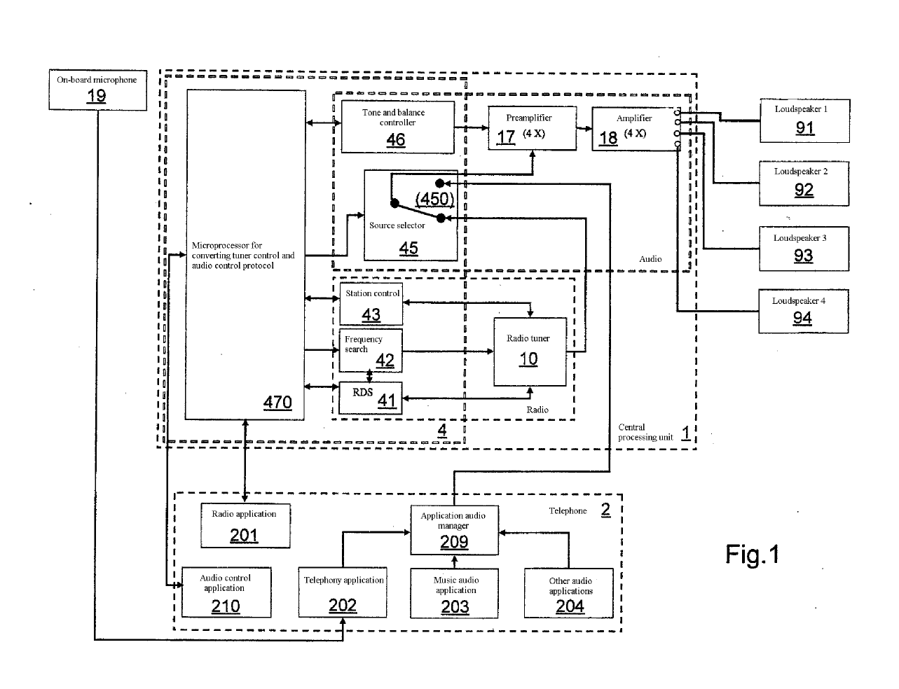

FIG. 1 shows the functional diagram of an on-board audio installation equipped with the kit according to the present invention,

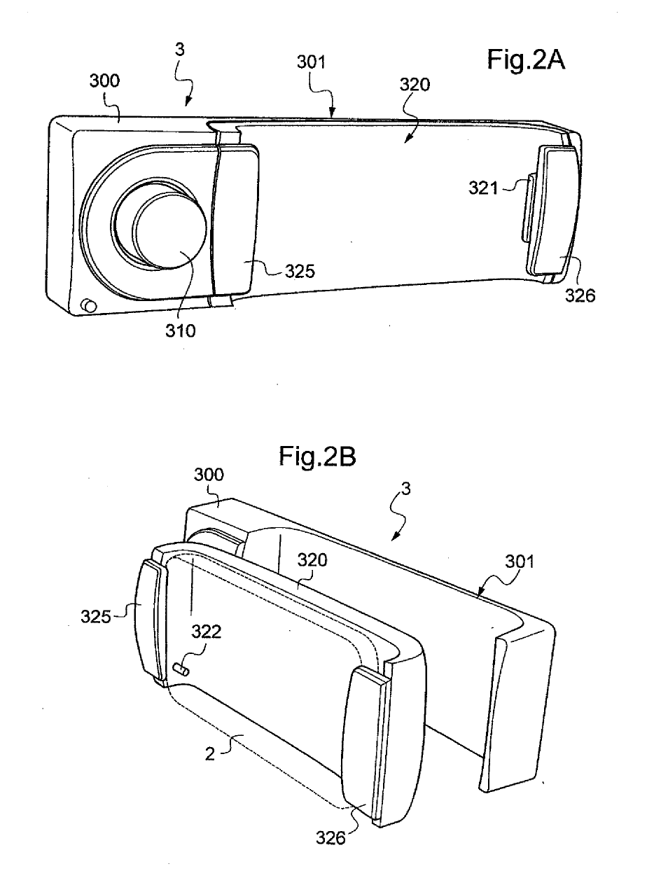

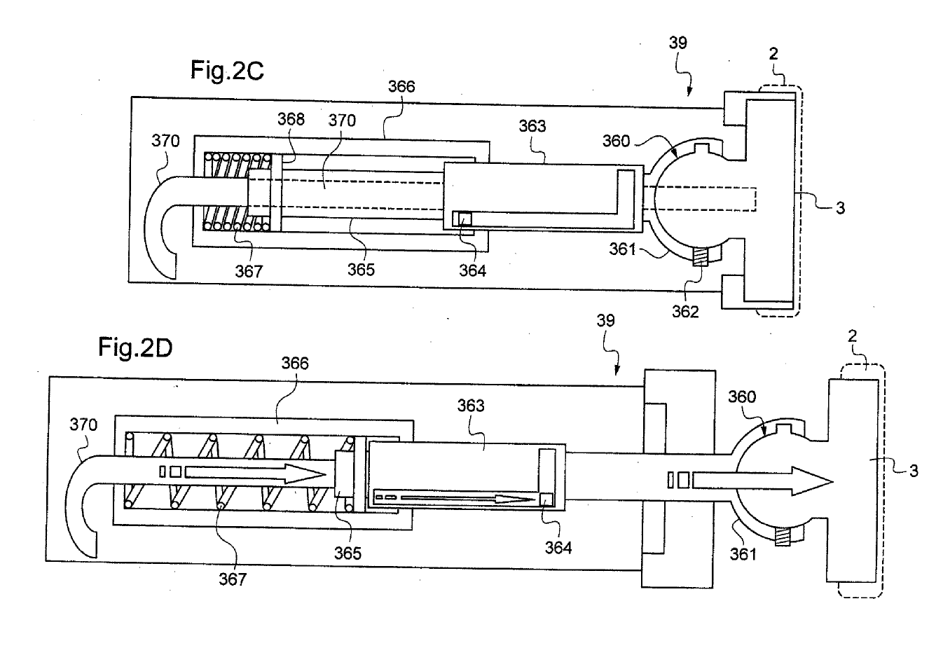

FIG. 2A shows, in perspective, a base for receiving a mobile telephone,

FIG. 2B shows, according to another perspective, the same base provided with a mobile telephone, in the elevated position,

FIG. 2C shows, in longitudinal section, a joining mechanism for the base in a first operating state,

FIG. 2D is analogous to FIG. 2C, the mechanism being in a second operating state,

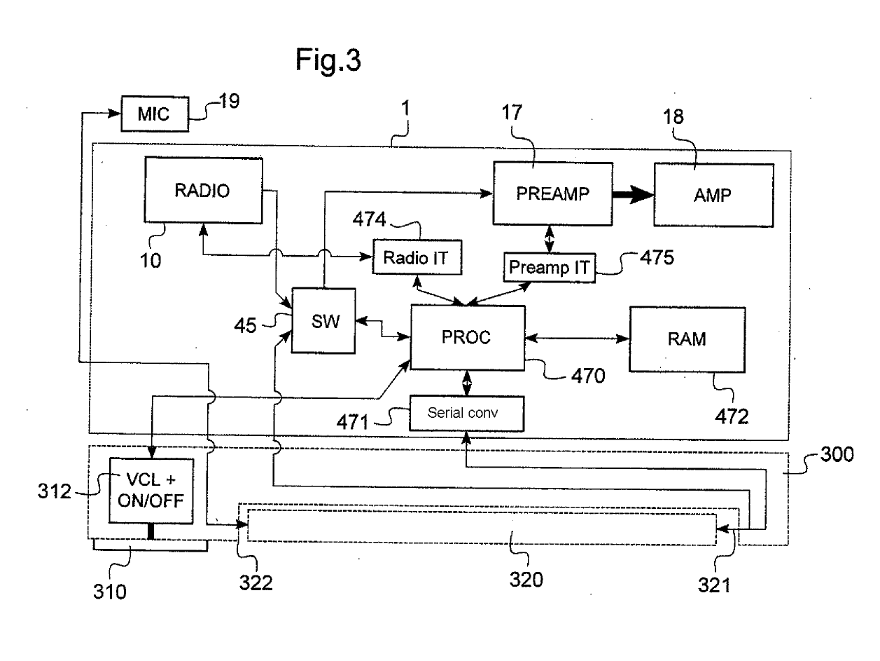

FIG. 3 is another functional diagram corresponding to that of FIG. 1 but focused more on the organisation of the hardware,

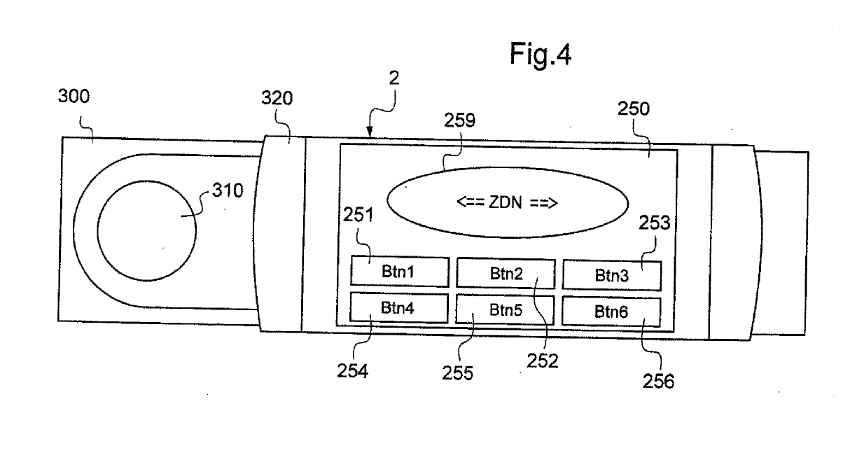

FIG. 4 shows schematically, in a front view, the telephone in the longitudinal position in the base, with a generic screen view,

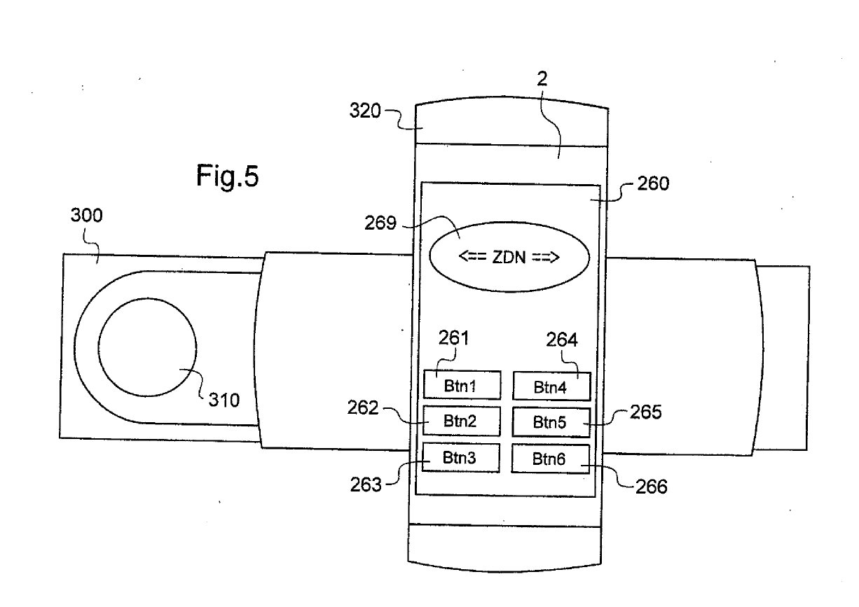

FIG. 5 shows schematically, in a front view, the telephone in the transverse position in the base, with a transposed generic screen view,

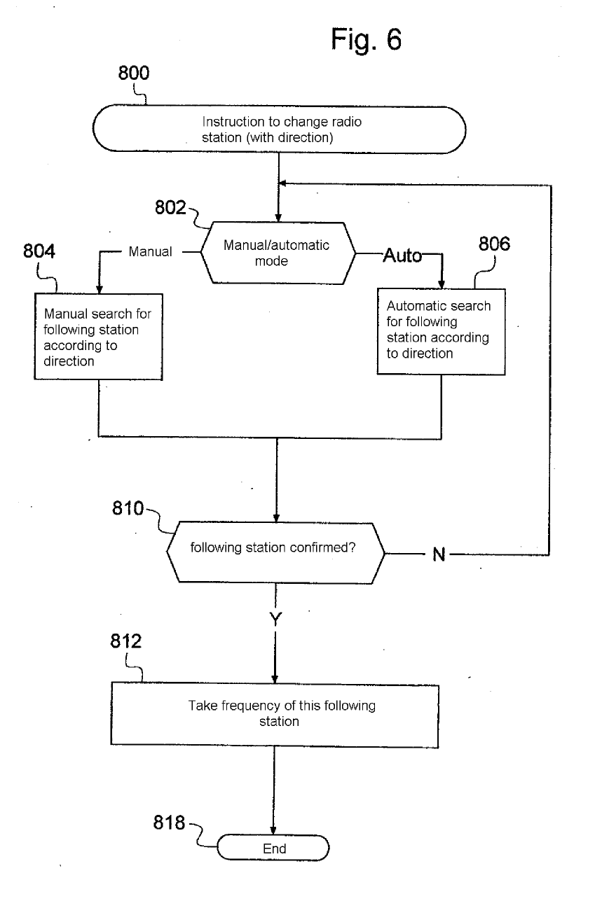

FIG. 6 is a flow diagram associated with a “select radio station” function,

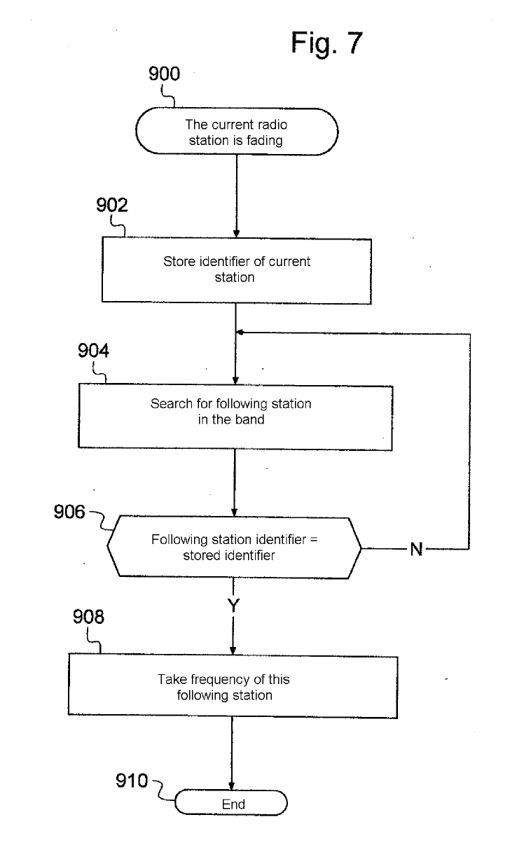

FIG. 7 is a flow diagram associated with a “radio station search-track” function, and

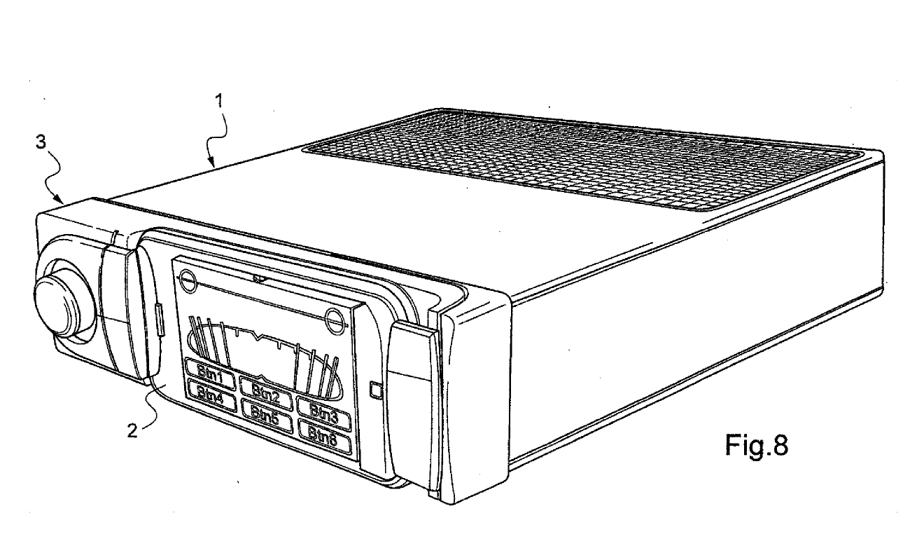

FIG. 8 is a perspective view showing the base with its telephone, mounted on the front face plate of an on-board car radio module.

The drawings and the description hereinbelow essentially contain elements of a specific nature. The drawings form an integral part of the description and may therefore not only serve for better understanding of the present invention but also contribute to its definition, where appropriate.

Reference will now be made to FIG. 1. It is an on-board radio installation for a motor vehicle.

The installation comprises a base module 1, which includes a radio tuner 10, a preamplifier 17 followed by an amplifier 18, which are both four-channel here. The number of channels is linked to the fact that the amplifier 18 supplies a system of electroacoustic transducers 91 to 94. In most cases there are four such transducers distributed inside the passenger compartment of the vehicle in order to obtain good acoustics (right/left and front/rear).

The tuner 10 is of a known type which provides an output in the form of two-way analogue audio signals.

In addition, it is known to interconnect a mobile telephone with an on-board audio installation for a motor vehicle. In that case, however, it is the on-board installation that assumes control of the mobile telephone. This operating mode lacks flexibility, especially with so-called “smart” mobile telephones (“smartphones”), which appeared some time ago. Moreover, many functions of the smart mobile telephone become difficult or even impossible to use, at least for the driver of the motor vehicle.

Among the “smart” mobile telephones, one of the most well-known is the “iPhone” (registered trade mark) model from Apple Corporation. Hereinbelow, the word “telephone” relates in principle to a smartphone of that type, or having substantially equivalent functionalities, at least as regards the functionalities under consideration here.

The present invention uses such a telephone, which is preferably mounted on the dashboard on a special support, as will be seen hereinbelow. The support allows the telephone to be connected to the dashboard.

The Applicant has decided to interconnect the telephone to the base module 1 through a relay conditioner assembly 4. The conditioner 4 will act as relay, from the point of view of both connection and data processing, between the telephone and the base module 1. To that end, it comprises a microprocessor 470 or the like.

The conditioner 4 here comprises:
a relay interface 41 for managing the “RDS” functions of the tuner 10,
a relay interface 42 for managing the search for radio stations,
a relay interface 43 for managing the selection and storing of a radio station,
a selector switch 45, and
a relay interface 46 for managing the control of the audio settings of the preamplifier 17.

The Applicant also proposes a set of “application software” or “applications” for the iPhone. Hereinbelow, they will simply be called “applications”. Accordingly, there is proposed for the telephone 2 of FIG. 1 a radio application 201 and an application manager 200.

The invention uses the group of telephony software and hardware functions 202 which are normally included in such a telephone. This group will be called “telephony application 202” for simplicity.

The telephony application 202 cooperates with an audio manager 209, which also centralises the sounds coming from other applications, such as a music audio application 203, which allows recorded or downloaded music files to be played, for example, or other applications with sound 204, such as games. Normally, the audio manager 209 sends the sounds to the loudspeakers of the telephone. However, the analogue sound signals are likewise sent to the main connector of the telephone, which can transmit a command for deactivation of the loudspeakers built into the telephone.

The radio application 201 will be described in greater detail below. Telephones with a built-in tuner exist, but they are not suitable for use in a motor vehicle. They do not permit reception above 50 km/h. Moreover, the functions of the tuner are basic and do not include, for example, a “Radio Data System” (RDS) function.

There is also provided a separate audio control application 210, which will also be discussed below.

A first aspect of the present invention will now be described.

The display of a telephone such as the iPhone is dependent upon the last application selected. There is therefore a software function which returns the last application selected. Moreover, as will be seen below, the telephone is able to indicate its state on the outside in the form of messages. Accordingly, the microprocessor 470 is able to know and store the applications that are currently running.

The microprocessor 470 will use that information to determine whether the last application called up among the applications is the radio application 201, or one of them. Accordingly, the selector switch 450 of the block with a switching function 45 feeds to the preamplifier 17:
A—the 2-way sound output of the tuner 10 if the last application seen by the application manager 200 is the radio application 201 (or an application associated with the radio)
B—otherwise, and by default, the 2-way digital output of the audio manager 209.

A variant would consist in also monitoring a predefined set of applications which are capable of producing a sound, such as, for example, the telephony application 202 and the audio application 203 and the application with sound 204. The microprocessor 470 determines whether one of those applications (of the predefined set) has been launched and not closed, in which case it actuates state B. It is possible to provide a state (C) in which the sound input to the preamplifier will be grounded.

In the particular embodiment described hereinbelow, the basic display (Table T1) of the radio application 201 imposes mode (A) above. Preferably, the same is true of the secondary settings display (Table T2).

The input of the preamplifier 17 is 2-way analogue. In a known manner, the preamplifier 17 can split the left and right input signals in order to distribute them as front and rear signals, as a function of a fader control.

The software realisation of the soft switch 450 is accessible to the person skilled in the art using, for example, the principles of data switches.

Mechanical aspects will now be considered.

FIGS. 2A to 2D show a particular embodiment of the telephone support 3, or base, used according to the present invention.

The base 3 comprises a support frame 300, the left-hand part of which receives a button 310 which can serve as volume control when rotated and as on/off button when pushed. For example, on a long push of two seconds, the device when switched on will generate a stop function. A short press engages or disengages the mute function in turned-on mode. When the device is switched off, a short press will turn the system on.

In its right-hand part 301, the frame receives a telephone holder 320 configured to the telephone in question, for example iPhone, with a main connector 321, visible on the right in FIG. 2A, and another connector 322, here a jack plug, visible on the left in FIG. 2B. Two holding flaps 325 and 326 are also provided.

The telephone 2 is positioned as follows. Its end is engaged beneath the flap 326 and then on the main connector 321. During this time, the connector 321 moves slightly in translation to the right against an elastic restoring force, for example a spring behind the connector. The element of the connector 321 that is on the side of the holder 320 then retracts against an elastic restoring force, so that the telephone can be engaged at the other end beneath the flap 325 and then on the jack plug 322 of the holder 320. The ends of the holder are shaped to follow the edges of the telephone, sufficiently to ensure that the telephone is held in place despite the vibrations experienced inside a vehicle. The height of the frame 300 is generally 58 mm. A telephone such as the iPhone, the small side of which measures 62 mm, therefore protrudes slightly. In many vehicles, it is necessary to extract the support 320 by 45 millimetres in order to be able to arrange the telephone in the support. Otherwise, the limited height of 58 mm is not sufficient to allow a telephone such as the iPhone to be inserted in landscape mode in this type of receiver.

FIG. 2B shows a different view of the frame 300, the holder 320 and, in this embodiment, a telephone 2 positioned in the holder 320. The holder is shown moved forwards, for example by about 45 millimetres. This movement allows the telephone to be pivoted between the position shown, which is horizontal, and a vertical position.

In an embodiment there are, from the inside to the outside: a mechanism permitting pivoting between the horizontal position and the vertical position, a ball permitting inclination to 45° at all angles, then the holder 320. The holder 320 is interconnected to the frame 300 by a cable which withstands rotation of 90° and is able to pass through the ball and the pivot mechanism.

The movement is as follows. With the telephone in position, the user pushes it, which unlocks it and causes it to move towards the user, with the holder 320, by about 45 mm relative to the frame 300. In that position, the telephone 2 and its holder 320 can be pivoted into a perpendicular position (FIG. 5). The angular position of the telephone is adjustable over +/−15°, both vertically and horizontally.

Reference will now be made to FIG. 2C to describe a manner of implementing the above.

The holder 320 of the telephone 2 is visible on the right, in abutment on a support structure 39 (comprising the frame 3 and elements to the rear). The support 39 is mounted on a ball 360 housed in a head 361. The ball is integral with a hollow central rod 365, which enters a cylinder 366 through an entry slider 363 and finishes in abutment on a piston 368 which compresses a spring 367 towards the bottom of the cylinder 366. A cable 370 passes through the whole to join the telephone connector inside the support frame 3. The slider 363 is fixed relative to the cylinder 366. It is provided with a pin 364 which is able to follow a horizontal cam groove first, starting from the left of the carriage, then an arc, as is visible to the right of the slider 363.

Finally, the piston 368 is provided with a snap-fit mechanism (not shown) which holds it in place, the spring 367 being compressed. The snap-fit mechanism is released by pushing to the left of the figure. Accordingly, a push on the telephone 2 and/or its holder 320 will drive the rod 365 to the left and free the piston 368 with which it is integral, and the spring 367 then moves the whole to the right, as shown in FIG. 2D. The cable 370 is provided with a resiliently urged reserve (not shown) in order to withstand the displacement without excessive tension.

At the same time, the pin 364 has reached the arc zone of the slider 363. It is therefore possible to pivot the assembly comprising the telephone 2 and the support 3 through 90° in the clockwise direction, for example.

It is also possible to incline the telephone 2 and its support 3 by more or less 15° in each direction. The path is limited by the pin 362 in cooperation with grooves in the ball 360.

The reverse operations will now be described. If the telephone is in the vertical position, it is returned to the horizontal position of FIG. 2D. From there, a push on the assembly until the piston 368 snaps back into the position of FIG. 2C returns everything to the initial state.

FIG. 3 shows a view of the hardware corresponding to FIG. 1. The bottom portion of FIG. 3 shows schematically the interconnections. There will be seen the holder 320 with, at its two ends, the connection at 321 for the main connector of the telephone and the connection at 322 for its headphone/microphone jack plug. On the left, the volume button 310 is associated with an electronic management system 312 which converts the on/off information into binary data and effects digital encoding of the volume command given by rotation of the button.

The whole is interconnected with the relay conditioner, which has been described functionally with reference to FIG. 1. It is shown here that the relay conditioner 4 is linked principally with a microprocessor 470 associated with a random access memory 472 (which can moreover be incorporated into the processor). The connection running to the jack 322 carries to the telephone the “micro” signal of an on-board microphone 19, while the fact that the jack plug is connected deactivates mechanically the microphone built into the telephone. The power connections, especially of the telephone, are not shown.

On its main connector, an iPhone (registered trade mark) delivers the lines indicated in table TOa below, inter alia (hence the discontinuous numbering of the pins).

TABLE T0a

| Pin | Signal | Description |
|---|---|---|
| 1 | GND | Ground (−) |
| 2 | GND | Audio & video ground (−) |
| 3 | Right | Line Out - R(+) (Audio output, right channel) |
| 4 | Left | Line Out - L(+) (Audio output, left channel) |
| 11 | GND | if grounded, sends the audio signals on pins 3-4 and |
| | | deactivates the internal loudspeaker |
| 12 | Tx | Serial TxD sending |
| 13 | Rx | Serial RxD receiving |
| 18 | 3.3 V | 3.3 V power (+) |
| 19, 20 | +12 V | Firewire Power 12 VDC (+) |
| 21 | Mode | indicates the type of accessory and validates the |
| | | serial mode (according to the resistor present) |
| 22 | TPA (−) | Fire Wire Data TPA (−) |
| 23 | 5 VDC (+) | USB power 5 VDC (+) |
| 24 | TPA (+) | Fire Wire Data TPA (+) |
| 25 | Data (−) | USB Data (−) |
| 26 | TPB (−) | FireWire Data TPB (−) |
| 27 | Data (+) | USB Data (+) and USB power mode |
| 28 | TPB (+) | FireWire Data TPB (+) |
| 29, 30 | GND | FireWire Ground (−) |

Pin 11 is grounded. Connection to the main connector 321 therefore has the effect of disconnecting the loudspeaker built into the iPhone and activating the audio outputs on pins 3 and 4. These audio outputs go to the switch 45.

At the base, the digital data are exchanged according to a serial protocol called “Apple Accessory Protocol for communication with IPOD”. The microprocessor 470 is provided with a serial interface 471 for dialogue with the telephone by digital data.

The message structure can be as shown in table T0b below.

TABLE T0b
Request/response message

| | | Size | |
|---|---|---|---|
| Id | Field | octets | Value |
| A | header | 2 | 0xFF 0x55 (in hexadecimal) |
| B | Length | 1 | Size of C + D + E (octets) |
| C | mode | 1 | the mode the command is referring to |
| D | command | 2 | 2-octet command |
| E | Parameter | 0 . . . n | optional parameters of the command |
| F | checksum | 1 | 0xXX—(8-bit additive checksum) |
| | | | 0x100—(sum of the octets of B + C + D + E & |
| | | | 0xFF) |

This structure permits numerous types of command/state data exchanges between the telephone and the microprocessor, each time using an appropriate “mode” datum. Such messages are customarily used to control the telephone remotely. Here, by contrast, they are also used by the telephone to deliver commands as a function of state data that it receives or which are available to it.

FIG. 3 shows an interface 474 for command/state data exchanges with the tuner 10. It also shows an interface 475 for command/state data exchanges with the preamplifier 17.

FIGS. 4 and 5 show the main elements of the telephone support which has just been described, with especially the frame 300, its on/off volume button 310, the holder 320, and the telephone 2 housed in the holder. An example 250 of a generic display used in the telephone is also shown.

FIG. 5 shows the same appearance, but with the telephone 2 in the vertical position. The display is modified in the manner shown at 260.

The present invention uses a generic display. In FIG. 4, the display includes a group of buttons, 251 to 256, to which the generic designations: “Btn1” to “Btn 6” have been assigned. Added to this is a navigation zone 259, which is an area of the screen which has been specially activated to allow a finger to move to right and left, for purposes which will be described below. The navigation zone can include a text display.

The display 260 of FIG. 4 has the same structure, except that the arrangement of the buttons and of the navigation zone on the screen has been altered. Elements 261 to 266 and 269 of FIG. 5 correspond to elements 251 to 256 and 259 of FIG. 4.

It is now possible to return to the description of the applications to be included in the telephone.

The radio application 201 of FIG. 1 has a basic display, which can be defined as defined in Table T1.

TABLE T1

| Location | Display |
|---|---|
| Btn1 to Btn6 | Preset radio stations |
| | (long press = the current station is stored) |
| ZDN | frequency adjustment + display of the current frequency |
| Top of screen | Name of the current radio station |
| | button: frequency band, |
| | button: settings |

There is also provided a secondary display, which can be a general setting display. This secondary display will assume control of certain “RDS” functions of the radio tuner 10. These are essentially the “station search 41” function and the “station control 42” function. The secondary display can be defined according to Table T2.

TABLE T2

| Location | Display |
|---|---|
| Btn1 to Btn6 | four buttons for: “LOCAL OFF”, “STEREO”, “AF ON”, |
| | “TA ON”; 2 buttons inactive |
| ZDN | passage to adjustment of display colours |
| Top of screen | button: return to main screen |

On the outside of the radio tuner 10, the following outputs are available:
current frequency
name of the station
current programme
mono/stereo
automatic frequency adjustment (AF) active or not
traffic info (TA for “traffic announcement”) active or not
local/distant reception (in FM)

On the outside of the radio tuner 10, the following inputs/commands are available:
manual search
automatic search
preselected station command. This can be effected by its name, with the so-called EON function, which brings together inter alia the name of the station (“PS” for Program Service) and the station identification code (“PI” for Programme Identity), which are also used in RDS
control of mono/stereo state
automatic frequency adjustment (AF) active or not
traffic alerts command (TA) active or not
local/distant reception command (in FM)

The exchange of data for the state commands: mono/stereo, automatic frequency adjustment (AF) active or not, traffic alerts (TA) active or not, local/distant reception (in FM) require only a conversion between the messages issued by the telephone and the state signals desired by the tuner.

The frequency adjustment 42 (selection of a radio station) is more complex because the tuner gives few possibilities for controlling this process. The mechanism used in the telephone will now be described with reference to FIG. 6.

At the input 800 is an instruction to change radio station (with direction) given by the telephone. The direction is defined by the direction of movement of the finger in the touch zone ZDN.

Depending on whether the mode is manual or automatic (802), the tuner is asked to search in manual mode (804) or in automatic mode (806) in the indicated direction (higher or lower frequencies). The tuner stops searching when it has found a station complying with the request. At 810, the use can confirm it. In the absence of confirmation, the system returns to 802. If the selection is confirmed, the new station is kept by the tuner and by the telephone (812), and that is the end of the operation (818). According to an interesting and more direct variant, the search stops at 810 and the station found remains active until the following search.

As regards the frequency command 43 (preset station), a short press on the button of a preset station calls it up as the new station. A long press takes the current station as the new preset station, recorded by its name “PS”.

Automatic station search 41 is also complex because the tuner gives no possibility for controlling this process, which is internal. The mechanism used in the telephone will now be described with reference to FIG. 7.

The initial state 900 is the fact that the current station is fading, which state is relayed from the tuner to the telephone by the microprocessor 470. At 902, the telephone stores an identifier PS name of the station and an identification code PI of the current station (see the connection between blocks 41 and 42 in FIG. 1). At 904, the tuner is given the instruction to scan the band, and that instruction is maintained until a different frequency is found (906) corresponding to the stored identifier (with identical PS and PI information), which becomes the new working frequency of the tuner (908). If an alternative frequency for the same station is not found, the search is continued over a complete cycle, and then the tuner returns to the last frequency used. And that is the end 910.

There will now be described the audio command application 210. The display screen for this application can be according to Table T3.

TABLE T3

| Location | Display |
|---|---|
| Btn1 | “Bass” |
| Btn2 | “Mid” |
| Btn3 | “Treble” |
| Btn4 | Subwoofer, a dedicated RCA output |
| Btn5 | Fader |
| Btn6 | Balance |
| ZDN | setting of the selected parameter + display of the name of |
| | that parameter, and of its current value |

The corresponding data and information are transmitted to the audio control function 46, which effects the conversion of data from the telephone into state commands of the preamplifier 17, in the form of analogue inputs/outputs.

FIG. 8 shows how the telephone 2 with its support 3 can form the front face plate of a bare car radio module 1 (without a front face plate). It has been described how it assumes control of the car radio module. Furthermore, all the functions proper to the telephone are retained. The relay conditioner 4 is advantageously housed in the module 1. In that case, the module 1 can form part of the kit according to the present invention.

Some aspects of the invention can be used independently of one another. For example, it is possible to use the station search management function and the radio station selection function in combination with an input selection mode of the preamplifier other than that described. Moreover, the RDS (“Radio Data System”) function is not strictly indispensable in a motor vehicle, although it is very useful for safety reasons.

1. Kit for an audiovisual device of a vehicle, of the type comprising
on the one hand a car radio module (1) without a front face plate, for mounting in a recess in the dashboard, in cooperation with a power supply, a radio antenna, and at least one on-board electro acoustic transducer (91-94), said car radio module being capable of automatically searching for stations, and
on the other hand means for controlling the car radio module,
characterised in that it further comprises
a base (300) for a so-called smart mobile telephone, the base being provided for mounting on the dashboard and comprising a connector (321) for the telephone, and its power supply,
at least one radio application (201) which is to be installed on the telephone in order to manage radio functions of the car radio module, the telephone itself comprising a telephony application (202) and an audio application manager (209),
a relay conditioner with a processor (4), which is arranged to be interconnected between the base and elements of the car radio module in order to receive from the telephone the audio signals of the applications with sound and to receive from a tuner (10) the radio audio signals, the relay conditioner comprising an input selection switch (450) for supplying a preamplifier (17), and
an audio input manager (470) which monitors the last application launched in order to control the input selection switch (450) according to whether the last application launched is or is not a radio application.

2. Kit according to claim 1, characterised in that it further comprises an amplification function control application (210), and in that the relay conditioner (4) comprises a converter (46) for controlling the preamplifier (17) as a function of parameters coming from said amplification function application.

3. Kit according to claim 1, characterised in that the relay conditioner (4) comprises a station search management function (41) and a radio station selection function (42, 43), both of which are under the control of said radio application.

4. Kit according to claim 1, characterised in that said applications are constructed from a basic user interface comprising a group of virtual buttons (251-256) surmounted by a delimited navigation zone (ZDN) which is sensitive to touch parallel to the major axis of the buttons.

5. Kit according to claim 4, characterised in that, for the amplification function control application, the buttons correspond to the parameters bass, mid, treble, balance and fade, while the delimited navigation zone (ZDN) allows the parameter corresponding to the last button actuated to be set.

6. Kit according to claim 4, characterised in that the radio application comprises a basic view where the buttons represent stored radio stations, while a current station is displayed in the delimited navigation zone (ZDN), which allows a station in the band to be selected.

7. Kit according to claim 4, characterised in that it comprises a setting application, one button of which controls whether or not the station search function is in use.

8. Kit according to claim 4, characterised in that it comprises an application for setting the colours of said basic user interface.

9. Kit according to claim 1, characterised in that the relay conditioner further comprises a connection (19) for establishing communication between an on-board microphone and the telephone, at least for the telephony application.

10. Kit according to claim 1, characterised in that the base is pivotable between a horizontal position and a vertical position.

11. Kit according to claim 2, characterised in that the relay conditioner (4) comprises a station search management function (41) and a radio station selection function (42, 43), both of which are under the control of said radio application.

12. Kit according to claim 2, characterised in that said applications are constructed from a basic user interface comprising a group of virtual buttons (251-256) surmounted by a delimited navigation zone (ZDN) which is sensitive to touch parallel to the major axis of the buttons.

13. Kit according to claim 5, characterised in that the radio application comprises a basic view where the buttons represent stored radio stations, while a current station is displayed in the delimited navigation zone (ZDN), which allows a station in the band to be selected.

14. Kit according to claim 5, characterised in that it comprises a setting application, one button of which controls whether or not the station search function is in use.

15. Kit according to claim 6, characterised in that it comprises a setting application, one button of which controls whether or not the station search function is in use.

16. Kit according to claim 5, characterised in that it comprises an application for setting the colours of said basic user interface.

17. Kit according to claim 6, characterised in that it comprises an application for setting the colours of said basic user interface.

18. Kit according to claim 7, characterised in that it comprises an application for setting the colours of said basic user interface.
